(19) United States
(12) Patent Application Publication
(10) Pub. No.: US 2005/0097624 A1
(43) Pub. Date: May 5, 2005

(54) System and associated terminal, method and computer program product for providing broadcast content

(75) Inventors: Juha H. Salo, Littoinen (FI); Janne La. Aaltonen, Turku (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/698,600

(22) Filed: Oct. 31, 2003

(51) Int. Cl. H04N 13/04; G06F 17/21; G06F 17/00; G06F 15/00; H04N 7/16; G06F 17/24

(52) U.S. Cl. 725/136; 715/500.1; 715/501.1; 725/32; 348/60

(57) ABSTRACT

A system for providing broadcast content includes a content source and a terminal. The content source, in turn, includes a continuity server capable of maintaining at least one piece of content and a schedule. The schedule specifies broadcast time(s) the content source broadcasts the piece(s) of content. In this regard, the content source can broadcast the piece(s) of content in accordance with the schedule. The terminal can store, in a memory, at least one piece of pre-broadcast content comprising the same piece(s) of content maintained by the continuity server. The terminal can therefore access at least one piece of pre-broadcast content from the memory in accordance with the schedule. Then, the terminal can present the accessed at least one piece of pre-broadcast content as the content source broadcasts the same at least one piece of content.

### FIELD OF THE INVENTION

The present invention generally relates to systems and methods for providing broadcast content and, more particularly, to systems, terminals, methods and computer program products for providing content prior to broadcast of such content, and thereafter presenting the content in synch with broadcast of the same content.

### BACKGROUND OF THE INVENTION

The deployment of advanced high bit-rate mobile networks has opened up new opportunities for delivering a host of services in a way that was not possible with earlier second generation wireless networks. Recent systems including third generation (3G) systems, such as those specified for use with the Global System for Mobile Communications (GSM) wireless standard, enable the delivery of new digital services such as video calls and the playback of multimedia applications that are comprised of audio and video clips. In this regard, the increased bit rates of 3G systems widen the possibilities for providing digital services.

The increased bit rates of 3G systems provide adequate performance for delivering high quality digital audio and acceptable quality moving image clips. However, at these transfer rates it may be difficult to handle exceedingly high data intensive tasks such as delivering high quality full-motion video and transferring very large data files to mobile terminals. In this regard, attempts at downloading large data files may lead to inconveniently long downloading times that can be undesirably costly for users. For this and other reasons, alternative broadband delivery techniques have been investigated that could provide a practical solution for high data intensive tasks in terms of lower cost and convenience for the users involved.

One such delivery technique that has shown promise is Digital Video Broadcasting (DVB). In this regard, DVB-T, which is related to DVB-C (cable) and DVB-S (satellite), is the terrestrial variant of the DVB standard. As is well known, DVB-T is a wireless point-to-multipoint data delivery mechanism developed for digital TV broadcasting, and is based on the MPEG-2 transport stream for the transmission of video and synchronized audio. DVB-T has the capability of efficiently transmitting large amounts of data over a broadcast channel to a high number of users at a lower cost, when compared to data transmission through mobile telecommunication networks using, e.g., 3G systems. Advantageously, DVB-T has also proven to be exceptionally robust in that it provides increased performance in geographic conditions that would normally affect other types of transmissions, such as the rapid changes of reception conditions, and hilly and mountainous terrain. On the other hand, DVB-H (handheld), which is also related to DVB-T, can provide such increased performance particularly for wireless data delivery to handheld devices.

Digital broadband data broadcast networks are known. As mentioned, an example of such a network enjoying popularity in Europe and elsewhere world-wide is DVB which, in addition to the delivery of television content, is capable of delivering data, such as Internet Protocol (IP) data. Other examples of broadband data broadcast networks include Japanese Terrestrial Integrated Service Digital Broadcasting (ISDB-T), Digital Audio Broadcasting (DAB), and MBMS, and those networks provided by the Advanced Television Systems Committee (ATSC). In many such systems, a containerization technique is utilized in which content for transmission is placed into MPEG-2 packets which act as data containers. Thus, the containers can be utilized to transport any suitably digitized data including, but not limited to High Definition TV, multiple channel Standard definition TV (PAUNTSC or SECAM) and, of course, broadband multimedia data and interactive services.

The combined use of mobile telecommunications with a broadband delivery technique such as DVB-T has been proposed in the past in order to achieve efficient delivery of digital services to users on the move. This would take advantage of existing infrastructures in the effort to provide personal communications (already prevalent) and the growing demand for Internet access, together with the expected rise of digital broadcasting, so that users can receive these services with a single device. Furthermore, DVB-T is a cross platform standard that is shared by many countries thereby making frequency compatibility and roaming less of an issue. The combination of mobile telecommunication and relatively very low cost digital broadband delivery techniques provides the possibility of interactive services such as uni-directional and bi-directional services such as audio and video streaming (e.g., TV, radio, etc.), file downloads and advanced gaming applications, etc. In this regard, many conventional mobile terminals are capable of downloading content for online use (e.g., streaming audio and/or video), and more increasingly also offline use (e.g., storing audio and/or video for subsequent access and presentation by the mobile terminal).

As will be appreciated, downloading content for online use typically assumes, at least to some extent, that such content is downloaded in one communication, or download, session. However, if the client is downloading large content, the time to download the content typically increases, thus increasing the probability that the client will encounter some type of delay, error or interruption in transmission during the download process. For example, an unexpected event, such as client error (e.g., dead battery, halt, crash, etc.), network failure (e.g., out of the geographic coverage area, etc.) or other network congestion due to the bandwidth requirements of downloading large content can delay or interrupt the transmission of download content. And as will be appreciated, such delays or interruptions in transmission then, can lead to reduced quality of service (QoS) for transmission and reception of such content.

### SUMMARY OF THE INVENTION

In light of the foregoing background, embodiments of the present invention provide an improved system and associated terminal, method and computer program product for providing broadcast content. Embodiments of the present invention permit a terminal to download or otherwise receive, and thereafter store, one or more pieces of broadcast content (i.e., pre-broadcast content) and a schedule for the broadcast of the content before a content source broadcasts the content. Accessibility to the stored pre-broadcast content can then be timed to a broadcasting time, such as a “public” broadcasting time, of the content, where the broadcasting time can be specified by the schedule. Embodiments of the present invention also permit a terminal to aggregate stored piece(s) of pre-broadcast content with live broadcast content, which can be downloaded or otherwise received by the terminal as a live stream. In this regard, embodiments of the present invention are capable of dividing the capacity of the network broadcasting the same content as stored by the terminal by delivering at least a portion of the content to be broadcasted prior the broadcasting time. As such, at the time the content source broadcasts the same content stored by the terminal, the terminal need not download or otherwise receive the broadcast content. The terminal can thus experience a “live” broadcast without requiring access to the broadcast content at the time the content is broadcast.

More particularly, in accordance with embodiments of present invention, a terminal is capable of storing piece(s) of broadcast content (i.e., pre-broadcast content) and a schedule for the broadcast of the content before a content source broadcasts the content. The terminal of embodiments of the present invention can then access and present the stored piece(s) of pre-broadcast content from memory as the content source broadcasts the content, and in a manner synchronous with the broadcast. As such, embodiments of the present invention are capable of providing broadcast content to the terminal in the same manner as if the terminal downloaded the content as the digital broadcaster broadcasts the content, but without requiring the terminal to download or otherwise receive the broadcast content, from the content source, as the broadcast content is broadcast. In this regard, embodiments of the present invention are capable of providing broadcast content to the terminal with an increased QoS, as compared to conventional techniques.

According to one aspect of the present invention, a system is provided for providing broadcast content. The system includes a content source and a terminal. The content source, in turn, includes a continuity server capable of maintaining piece(s) of content and a schedule. The schedule specifies at least one broadcast time the content source broadcasts the piece(s) of content. In this regard, the content source is capable of broadcasting the piece(s) of content in accordance with the schedule. The terminal is capable of storing, in a memory, piece(s) of pre-broadcast content comprising the same piece(s) of content maintained by the continuity server. The terminal can be capable of storing the piece(s) of pre-broadcast content before the content source broadcasts the same piece(s) of content.

The content source can be capable of sending, and the terminal receiving, the piece(s) of content maintained by the continuity server. For example, the content source can be capable of sending, and the terminal receiving, the piece(s) of content in accordance with techniques such as those specified by DVB-T, GPRS, EDGE or the like. The terminal can then be capable of storing the received piece(s) of content as the piece(s) of pre-broadcast content. In various instances, the content source can be capable of processing the piece(s) of content, such as by encoding and/or transcoding the piece(s) of content before sending the piece(s) of content to the terminal. In such instances, when the piece(s) of content comprise encoded piece(s) of content, the terminal can be capable of receiving the encoded piece(s) of content and thereafter decoding the encoded piece(s) of content.

In addition to receiving and storing the piece(s) of pre-broadcast content, the terminal can also access the piece(s) of pre-broadcast content from the memory in accordance with the schedule. Then, the terminal can present the accessed piece(s) of pre-broadcast content as the content source broadcasts the same piece(s) of content. The terminal can additionally be capable of synchronizing the accessed piece(s) of pre-broadcast content with the same piece(s) of content broadcast by the content source before presenting the accessed piece(s) of pre-broadcast content. In such instances, the terminal can be capable of presenting the synchronized piece(s) of pre-broadcast content.

The terminal can further be capable of releasing each piece of pre-broadcast content when a current time of the terminal matches the broadcast time the content source broadcasts the same piece of content. The terminal can then be capable of accessing the released piece(s) of pre-broadcast content. In various instances, the content source is capable of broadcasting the piece(s) of content when a current time of the content source matches the at least one broadcast time of the schedule. Thus, before or as the terminal releases the piece(s) of pre-broadcast content, the terminal can be capable of synchronizing the current time of the terminal with the current time of the content source. The terminal can also be capable of expiring each released piece of pre-broadcast content when the current time is subsequent to the broadcast time. The terminal can then maintain in the memory, and/or delete from the memory, at least one expired piece of pre-broadcast content. More particularly, the terminal can be capable of maintaining at least one expired piece of pre-broadcast content in the memory of the terminal, and thereafter overwriting at least one expired piece of pre-broadcast content with at least one subsequent piece of pre-broadcast content.

The schedule maintained by the continuity server can be capable of specifying at least one broadcast time the content source broadcasts piece(s) of live broadcast content, in addition to specifying at least one broadcast time the content source broadcasts the piece(s) of content. In such instances, the terminal can be capable of receiving piece(s) of live broadcast content when a current time matches the broadcast time of the respective piece(s) of live broadcast content. Thus, the terminal can be capable of accessing piece(s) of pre-broadcast content stored by the terminal and/or piece(s) of live broadcast content received by the terminal. Likewise, the terminal can be capable of presenting the accessed piece(s) of pre-broadcast content and/or the accessed piece(s) of live broadcast content.

The terminal can be capable of storing the schedule maintained by the continuity server. In this regard, the schedule can include at least one slot specifying broadcast of a selectable piece of pre-broadcast content at a respective broadcast time. In such instances, the terminal can be capable of receiving a selection of at least one piece of pre-broadcast content for the slot(s). Thereafter, the terminal can modify the schedule to specify the selected piece(s) of pre-broadcast content in the slot(s). In another embodiment, the schedule can include at least one slot specifying a broadcast time and a piece of pre-broadcast content. In such instances, the terminal can be capable of receiving at least one slot of the schedule. Then, the terminal can be capable of accessing at least one piece of pre-broadcast content in accordance with the slot(s) received by the terminal.

According to other aspects of the present invention, a terminal, method and computer program product are presented for providing broadcast content. Therefore, embodiments of the present invention provide an improved system and associated terminal, method and computer program product for providing broadcast content. In this regard, the terminal of embodiments of the present invention is capable of performing the functions of a continuity server of a content source providing such broadcast content. And by performing the functions of a continuity server, the terminal of embodiments of the present invention is capable of storing broadcast content, otherwise stored by the content source, before a content source broadcasts the same content as specified by a schedule.

As the content source broadcasts the content specified by the schedule, whether stored or live broadcast content, the terminal can retrieve the same stored content from local memory or receive the live broadcast content and present the content in a manner synchronous with the broadcast. As such, the terminal is capable of presenting broadcast content as the content is broadcast without downloading the otherwise stored portions of the content at the time of broadcast. The terminal can therefore be capable of presenting the broadcast content irrespective of errors, interruptions or delays that may occur in the download of such content as the content is broadcast. Therefore, the system and associated terminal, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one embodiment of the present invention including a cellular network and a data network to which a terminal is bi-directionally coupled through wireless RF links;

FIG. 2 is a schematic block diagram of an entity capable of operating as a terminal, origin server, digital broadcast receiving terminal and/or a digital broadcaster, in accordance with embodiments of the present invention;

FIG. 3 is a functional block diagram of a digital broadcast receiving terminal, in accordance with one embodiment of the present invention;

FIG. 4 is a functional block diagram of the digital broadcaster, in accordance with one embodiment of the present invention;

FIG. 5 is a schematic illustration of a portion of a schedule including slots specifying times for one or more pieces of content comprising television programs, in accordance with one embodiment of the present invention;

FIG. 6 is a schematic block diagram of a mobile station that may operate as a terminal, according to embodiments of the present invention;

FIGS. 7A and 7B are functional block diagrams of terminals downloading content from a content source, in accordance with embodiments of the present invention; and

FIGS. 8A and 8B are flowcharts of methods of providing broadcast content, in accordance with embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

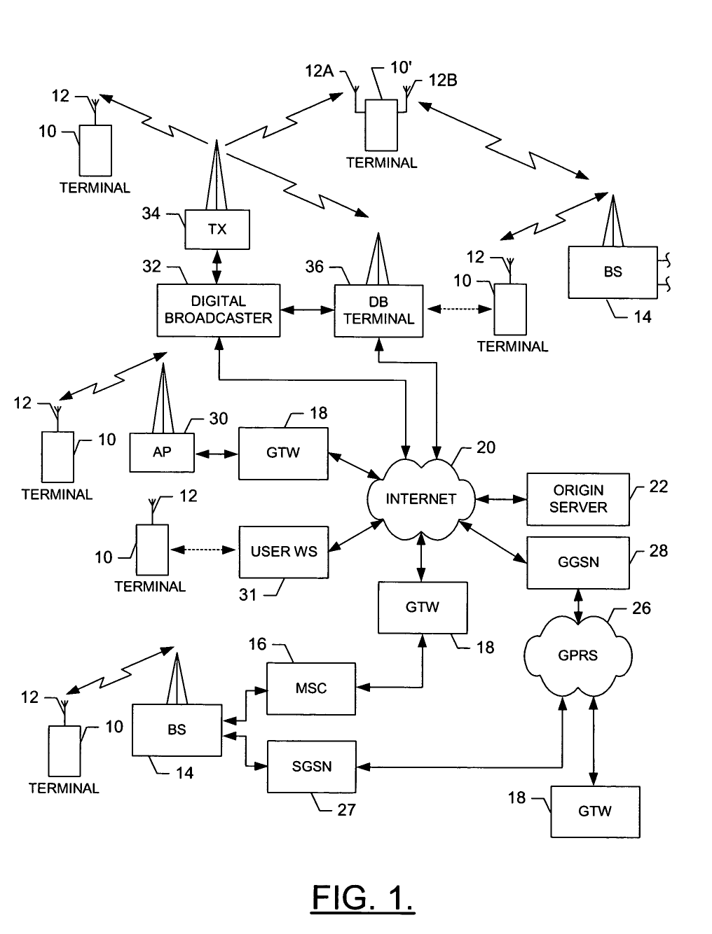

Referring to FIG. 1, an illustration of one type of terminal and system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g., Internet) applications.

As shown, a terminal 10 may include an antenna 12 for transmitting signals to and for receiving signals from a base site or base station (BS) 14. The base station is a part of a cellular network that includes elements required to operate the network, such as a mobile switching center (MSC) 16. As well known to those skilled in the art, the cellular network may also be referred to as a Base Station/MSC/Interworking function (BMI). In operation, the MSC is capable of routing calls and messages to and from the terminal when the terminal is making and receiving calls. The MSC also provides a connection to landline trunks when the terminal is involved in a call. Further, the MSC can be coupled to a server gateway (GTW) 18.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 18, and the GTW is coupled to a WAN, such as the Internet 20. In turn, devices such as processing elements (e.g., personal computers, server computers or the like) can be coupled to the terminal 10 via the Internet. For example, as explained below, the processing elements can include one or more processing elements associated with an origin server 22 or the like, one of which being illustrated in FIG. 1.

In addition to the MSC 16, the BS 14 can be coupled to a signaling GPRS (General Packet Radio Service) support node (SGSN) 24. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 26. The packet-switched core network is then coupled to another GTW, such as a GTW GPRS support node (GGSN) 28, and the GGSN is coupled to the Internet. In addition to the GGSN, the packet-switched core network can also be coupled to a GTW 18.

By coupling the SGSN 24 to the GPRS core network 26 and the GGSN 28, devices such as origin servers 22 can be coupled to the terminal 10 via the Internet 20, SGSN and GGSN. In this regard, devices such as origin servers can communicate with the terminal across the SGSN, GPRS and GGSN. For example, origin servers can provide content to the terminal, such as in accordance with the Multimedia Broadcast Multicast Service (MBMS). For more information on the MBMS, see Third Generation Partnership Project (3GPP) technical specification 3GPP TS 22.146, entitled: Multimedia Broadcast Multicast Service (MBMS), the contents of which are hereby incorporated by reference in its entirety.

In addition to being coupled to the BS 14, the terminal 10 can be coupled to one or more wireless access points (APs) 30. The APs can comprise access points configured to communicate with the terminal in accordance techniques such as, for example, radio frequency (RF), Bluetooth (BT), infrared (IrDA) or any of a number of different wireless networking techniques, including WLAN techniques. Additionally, or alternatively, the terminal can be coupled to one or more user workstations (WS) 31. Each user workstation can comprise a computing system such as personal computers, laptop computers or the like. In this regard, the user workstations can be configured to communicate with the terminal in accordance with techniques such as, for example, RF, BT, IrDA or any of a number of different wireline or wireless communication techniques, including LAN and/or WLAN techniques. One or more of the user workstations can additionally, or alternatively, include a removable memory capable of storing content, which can thereafter be transferred to the terminal.

The APs 30 and the workstations 31 may be coupled to the Internet 20. Like with the MSC 16, the APs and workstations can be directly coupled to the Internet. In one advantageous embodiment, however, the APs are indirectly coupled to the Internet via a GTW 18. As will be appreciated, by directly or indirectly connecting the terminals and the origin server 22, as well as any of a number of other devices, to the Internet, the terminals can communicate with one another, the origin server, etc., to thereby carry out various functions of the terminal, such as to transmit data, content or the like to, and/or receive content, data or the like from, the origin server. As used herein, the terms “data,” “content,” “information” and similar terms may be used to interchangeably to refer to data capable of being transmitted, received and/or stored in accordance with embodiments of the present invention. Thus, use of any such terms should not be taken to limit the spirit and scope of the present invention.

Further, the terminal 10 can additionally, or alternatively, be coupled to a digital broadcaster 32 via a digital broadcast network, such as a terrestrial digital video broadcasting (e.g., DVB-T, DVB-H, ISDB-T, ATSC, etc.) network. As will be appreciated, by directly or indirectly connecting the terminals and the digital broadcaster, the terminals can receive content, such as content for one or more television, radio and/or data channels, from the digital broadcaster. In this regard, the digital broadcaster can include, or be coupled to, a transmitter (TX) 34, such as a DVB-T TX. Similarly, the terminal can include a receiver, such as a DVB-T receiver (not shown). The terminal can be capable of receiving content from any of a number of different entities in any one or more of a different number of manners. In one embodiment, for example, the terminal can comprise a terminal 10′ capable of transmitting and/or receiving data, content or the like in accordance with a DVB (e.g., DVB-T, DVB-H, etc.) technique as well as a cellular (e.g., 1G, 2G, 2.5G, 3G, etc.) communication technique. In such an embodiment, the terminal 10′ may include an antenna 12A for receiving content from the DVB-T TX, and another antenna 12B for transmitting signals to and for receiving signals from a BS 14. For more information on such a terminal, see U.S. patent application Ser. No. 09/894,532, entitled: Receiver, filed Jun. 29, 2001, the contents of which is incorporated herein by reference in its entirety.

In addition to, or in lieu of, directly coupling the terminal 10 to the digital broadcaster 32 via the TX 34, the terminal can be coupled to a digital broadcast (DB) receiving terminal 36 which, in turn, can be coupled to the digital broadcaster 32, such as directly and/or via the TX. In such instances, the digital broadcast receiving terminal can comprise a DVB-T receiver, such as a DVB-T receiver in the form of a set top box. The terminal can be locally coupled to the digital broadcast receiving terminal, such as via a personal area network. In one advantageous embodiment, however, the terminal can additionally or alternatively be indirectly coupled to the digital broadcast receiving terminal via the Internet 20.

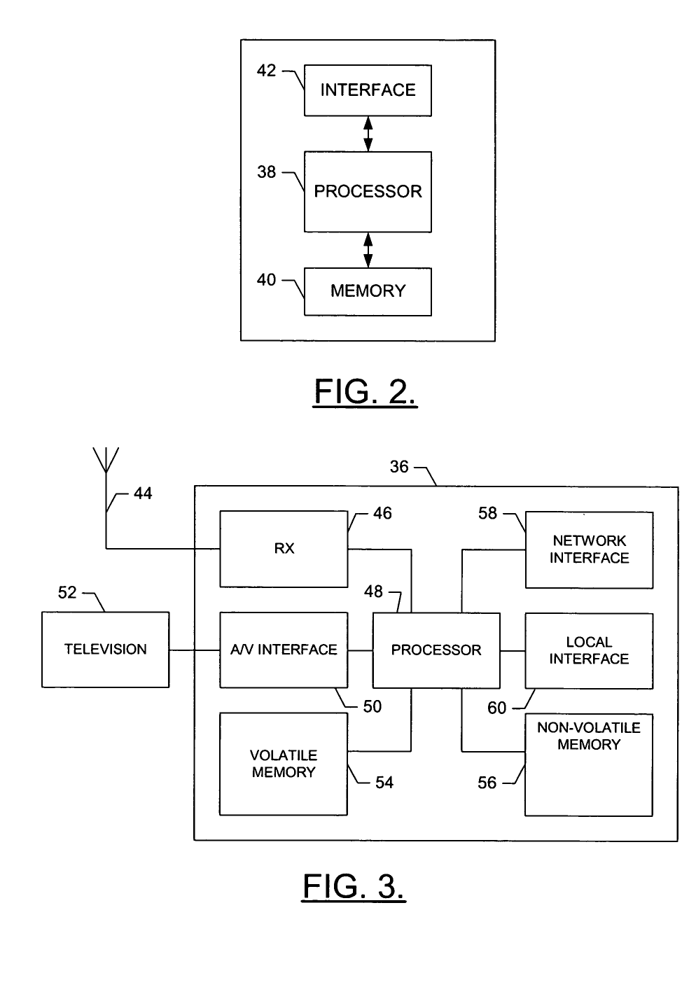

Referring now to FIG. 2, a block diagram of an entity capable of operating as a terminal 10, origin server 22, digital broadcast receiving terminal 36, and/or a digital broadcaster 32 is shown in accordance with one embodiment of the present invention. Although shown as separate entities, in some embodiments, one or more entities may support one or more of a terminal, origin server, digital broadcast receiving terminal, and/or a digital broadcaster, logically separated but co-located within the entit(ies). For example, a single entity may support a logically separate, but co-located, terminal and digital broadcast receiving terminal. Also, for example, a single entity may support a logically separate, but co-located digital broadcast receiving terminal and digital broadcaster.

As shown, the entity capable of operating as a terminal 10, origin server 22, digital broadcast receiving terminal 36, and/or a digital broadcaster 32 can generally include a processor 38 connected to a memory 40. The processor can also be connected to at least one interface 42 or other means for transmitting and/or receiving data, content or the like. The memory can comprise volatile and/or non-volatile memory, and typically stores content, data or the like. For example, the memory typically stores software applications, instructions or the like for the processor to perform steps associated with operation of the entity in accordance with embodiments of the present invention. Also, for example, the memory typically stores content transmitted from, or received by, the terminal, digital broadcast receiving terminal, and/or digital broadcaster.

Reference is now made to FIG. 3, which illustrates a functional block diagram of a digital broadcast receiving terminal 36, in accordance with one embodiment of the present invention. As shown, the digital broadcast receiving terminal includes an antenna 44 for receiving signals from a digital broadcaster 32 and feeding the signals into a receiver (RX) 46. In turn, the receiver is capable of decrypting, demodulating and/or demultiplexing the signals, such as to extract content data. The receiver can feed the content data to a processor 48, which can thereafter decode the content data. The processor can then feed the decoded signal into an audio/video (AN) interface 50, which can convert signals to a form suitable for display by a monitor, such as a television set 52.

The digital broadcast receiving terminal 36 can include volatile memory 54, such as volatile Random Access Memory (RAM) including a cache area for the temporary storage of data. The digital broadcast receiving terminal can also include non-volatile memory 56, which can be embedded and/or may be removable. The non-volatile memory can additionally or alternatively comprise an EEPROM, flash memory, hard disk or the like. The memories can store any of a number of pieces of information, content and data, used by the digital broadcast receiving terminal to implement the functions of the digital broadcast receiving terminal. For example, as indicated above, the memories can store content, such as that received from a digital broadcaster 32.

The digital broadcast receiving terminal 36 can also include one or more interface means for sharing and/or obtaining data from electronic devices, such as terminals 10 and/or digital broadcasters 32. More particularly, the digital broadcast receiving terminal can include a network interface means 58, for sharing and/or obtaining data from a network, such as the Internet 20. For example, the digital broadcast receiving terminal can include an Ethernet Personal Computer Memory Card International Association (PCMCLA) card configured to transmit and/or receive data to and from a network, such as the Internet.

The digital broadcast receiving terminal 36 can also include one or more local interface means 60 for locally sharing and/or obtaining data from electronic devices, such as a terminal. For example, the digital broadcast receiving terminal can include a radio frequency transceiver and/or an infrared (IR) transceiver so that data can be shared with and/or obtained in accordance with radio frequency and/or infrared transfer techniques. Additionally, or alternatively, for example, the digital broadcast receiving terminal can include a Bluetooth (BT) transceiver 52 operating using Bluetooth brand wireless technology developed by the Bluetooth Special Interest Group such that the digital broadcast receiving terminal can share and/or obtain data in accordance with Bluetooth transfer techniques. Further, the digital broadcast receiving terminal can additionally or alternatively be capable of sharing and/or obtaining data in accordance with any of a number of different wireline and/or wireless networking techniques, including LAN and/or WLAN techniques.

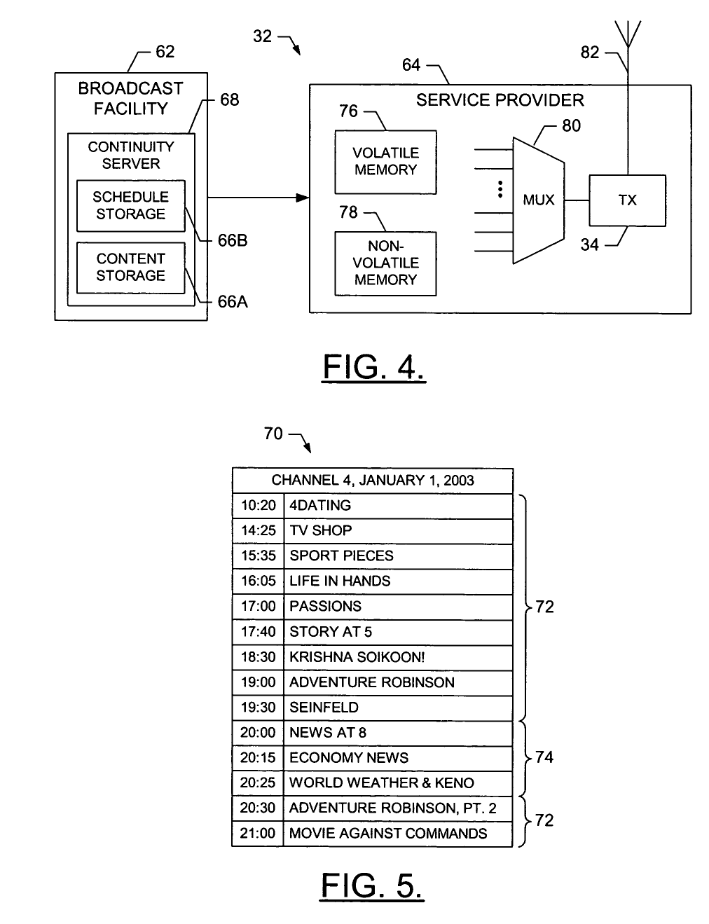

Reference is now made to FIG. 4, which illustrates a functional block diagram of the digital broadcaster 32 of one embodiment of the present invention. As shown, the digital broadcaster can include one or more broadcast facilities 62 capable of providing content to a digital broadcast service provider 64. Each broadcast facility can include volatile memory, such as volatile Random Access Memory (RAM) including a cache area for the temporary storage of data. The digital broadcaster can also include non-volatile memory, which can be embedded and/or may be removable. The non-volatile memory can additionally or alternatively comprise an EEPROM, flash memory, hard disk or the like. The memories can include, for example a content storage 66A and a schedule storage 66B. In this regard, each broadcast facility can include a continuity server 68 capable of storing one or more pieces of broadcast content, such as commercial and non-commercial broadcast television or radio content, in the content storage. In addition, the continuity server can be capable of storing a schedule in the schedule storage, where the schedule includes one or more slots specifying broadcast times, including dates, for one or more pieces of broadcast content over a period of time (e.g., year, month, week, day, etc.), including content stored by the content storage.

In addition to including piece(s) of content stored in content storage 66A, the schedule stored in schedule storage 66B can include one or more slots specifying the broadcast times, including dates, for one or more pieces of live broadcast content, such as news, sporting events or the like, which are incapable of being pre-stored in the content storage for any appreciable amount of time. For example, a schedule including one or more slots specifying one or more pieces of broadcast news content can specify one or more news stories from content storage, as well as one or more pieces of live broadcast content, such as news anchor narratives for the news stories. In this regard, the live broadcast content can be produced the broadcast facilities 62 and provided to the digital broadcast service provider 64 as the respective content is produced.

Referring to FIG. 5, a schedule 70 for the broadcast of content over a nine hour period includes slots specifying pieces of content comprising television programs, many of which are stored in the content storage 66A of a respective broadcast facility 62. More particularly, the schedule can include slots specifying one or more programs 72 capable of being stored in the content storage, and subsequently provided to the digital broadcast service provider 64. In addition, the schedule can include a slot for each of one or more live programs 74, such as news programs, capable of being provided to the digital broadcast service provider in “real time” as the live programs are produced. Generally, then, each schedule stored in schedule storage 66B can include one or more slots specifying pieces of broadcast content stored in the content storage, and can include one or more pieces of live broadcast content.

Like the digital broadcast receiving terminal 36, the digital broadcast service provider 64 of the digital broadcaster 32 can include volatile memory 76, such as volatile Random Access Memory (RAM) including a cache area for the temporary storage of data. The digital broadcaster can also include non-volatile memory 78, which can be embedded and/or may be removable. The non-volatile memory can additionally or alternatively comprise an EEPROM, flash memory, hard disk or the like. The memories can store any of a number of pieces of information, content and data, used by the digital broadcaster to implement the functions of the digital broadcaster. For example, as indicated above, the memories can store content, such as content for a television channel and other content for a number of other television, radio and/or data channels, as such can be provided by the broadcast facilities 62.

The digital broadcast service provider 64 of the digital broadcaster 32 can also include a multiplexer 80, which can be capable of multiplexing content for a number of television, radio and/or data channels, such as those provided by the broadcast facilities 62. In this regard, the multiplexer can be capable of multiplexing content for broadcast in accordance with a schedule 70 stored in schedule storage 66B of a broadcast facility 64. The multiplexer can then feed the resulting signal into a TX 34, which can be separate from the digital broadcaster, or more particularly the digital broadcast service provider, as shown in FIG. 1, or incorporated within the digital broadcaster, as shown in FIG. 4.

Irrespective of where the TX 34 is located relative to the digital broadcaster 32, the TX can receive the signal from the multiplexer 80 for encryption, modulation, amplification and/or transmission, such as via an antenna 82. For example, the digital broadcaster can be capable of directly or indirectly transmitting content to a digital broadcast receiving terminal 36 and/or a terminal 10, such as in accordance with a digital broadcasting technique, such as DVB-T. In this regard, the digital broadcaster can be capable of transmitting broadcast content, including one or more pieces of broadcast content stored by the content storage 66A of the broadcast facility 64, and/or one or more pieces of live broadcast content, in accordance with the times specified for the respective pieces of content in a schedule 70 stored by the schedule storage 66B. For information on DVB-T, see European Telecommunications Standards Institute (ETSI) Standard EN 300 744, entitled: Digital Video Broadcasting (DVB): Framing structure, channel coding and modulation for digital terrestrial television, v. 1.1.2 (1997) and related specifications, the contents of which are hereby incorporated by reference in their entirety.

In accordance with a number of digital broadcasting techniques, such as DVB-T, Internet Protocol (IP) Datacast (IPDC) can be utilized to provide audio, video and/or other content to terminals 10. In this regard, the digital broadcaster 32 can be capable of providing IP datacasting content to the terminal utilizing a digital broadcasting technique. As will be appreciated by those skilled in the art, digital broadcasting techniques such as DVB-T are essentially cellular in nature with a transmission site associated with each of a number of different cells. DVB-T, for example, uses MPEG-2 transport streams, and as such, IP data can be encapsulated into DVB transmission signals sent from the digital broadcaster, or more particularly the TX 34. Data streams including IP datagrams can be supplied from several sources, and can be encapsulated by an IP encapsulator (not shown). The IP encapsulator, in turn, can feed the encapsulated IP data streams into the data broadcasting (e.g., DVB-T) network.

The encapsulated IP data streams can then be transported to one or more transmission sites, where the transmission sites form cells of the data broadcasting network. For example, the encapsulated IP data streams can be transported to one or more transmission sites on an MPEG-2 transport stream for subsequent transmission over the air directly to the terminals, or to a receiver station serving one or more terminals. As will be appreciated, the MPEG-2 transport stream, from production by the IP encapsulator, to reception by the terminals or the receiver station, is typically uni-directional in nature. In this regard, IP packets containing the data can be embedded in multi-protocol encapsulation (MPE) sections that are transported within transport stream packets.

In addition to the IP packets, the MPE sections can also include forward error correction (FEC) information and time slicing information. By including information such as time slicing information, data can be conveyed discontinuously with the receiver (e.g., terminal 10), being capable of saving battery power by switching off when no data is being transmitted to the receiver. In other terms, in accordance with one time slicing technique, instead of using the current default method of continuous digital broadcasting (e.g., DVB-T) transmission, a time division multiplex-type of allocation technique can be employed (see, e.g., DVB-H standard). With such an approach, then, services can be provided in bursts, allowing a receiver to power down when the receiver is not receiving data, and allowing the receiver to power up to receive data packets, as necessary.

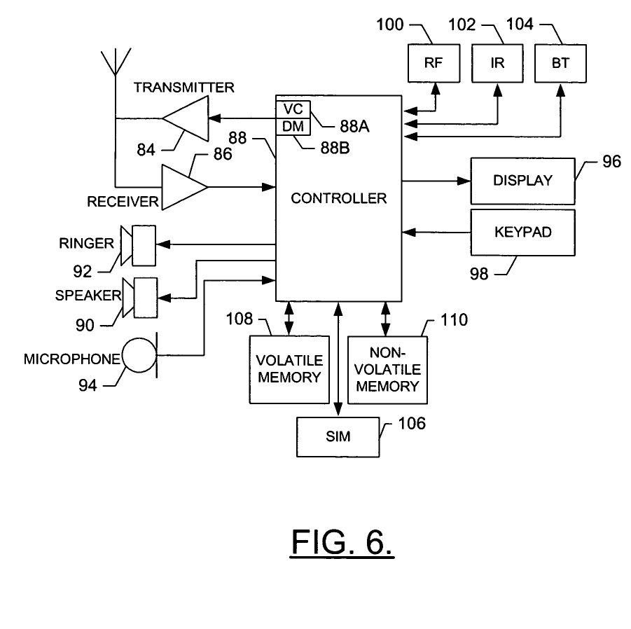

FIG. 6 illustrates a functional diagram of a mobile station that may operate as a terminal 10, according to embodiments of the invention. It should be understood, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes a transmitter 84, a receiver 86, and a controller 88 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first-generation (1G), second-generation (2G), 2.5G and/or third-generation (3G) communication protocols or the like. For example, the mobile station may be capable of operating in accordance with 2G wireless communication protocols IS-136 (TDMA), GSM, IS-95 (CDMA) or the like. Also, for example, the mobile station may be capable of operating in accordance with 2.5G wireless communication protocols GPRS, Enhanced Data GSM Environment (EDGE), or the like. The mobile station can additionally or alternatively be capable of operating in accordance with any of a number of different digital broadcasting techniques, such as the DVB technique (e.g., DVB-T, ETSI Standard EN 300 744). The mobile station can also be capable of operating in accordance with any of a number of different broadcast and/or multicast techniques, such as the MBMS technique (e.g., 3GPP TS 22.146). Further, the mobile station can be capable of operating in accordance with ISDB-T, DAB, ATSC techniques or the like. Some narrow-band AMPS (NAMPS), as well as TACS, mobile stations may also benefit from embodiments of the present invention, as should dual or higher mode mobile stations (e.g., digital/analog or TDMA/CDMA/analog phones).

It is understood that the controller 88 includes the circuitry required for implementing the audio and logic functions of the mobile station. For example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 88A, and may include an internal data modem (DM) 88B.

Further, the controller may include the functionally to operate one or more software applications, which may be stored in memory. The mobile station also comprises a user interface including a conventional earphone or speaker 90, a ringer 92, a microphone 94, a display 96, and a user input interface, all of which are coupled to the controller 88. The user input interface, which allows the mobile station to receive data, can comprise any of a number of devices allowing the mobile station to receive data, such as a keypad 98, a touch display (not shown) or other input device. In embodiments including a keypad, the keypad includes the conventional numeric (0-9) and related keys (#, *), and other keys used for operating the mobile station.

The mobile station can also include one or more means for sharing and/or obtaining data from electronic devices, such as another terminal 10, an origin server 22, an AP 30, a digital broadcast receiving terminal 36, a digital broadcaster 32 or the like, in accordance with any of a number of different wireline and/or wireless techniques. For example, the mobile station can include a radio frequency (RF) transceiver 100 and/or an infrared (IR) transceiver 102 such that the mobile station can share and/or obtain data in accordance with radio frequency and/or infrared techniques. Also, for example, the mobile station can include a Bluetooth (BT) transceiver 104 such that the mobile station can share and/or obtain data in accordance with Bluetooth transfer techniques. Although not shown, the mobile station may additionally or alternatively be capable of transmitting and/or receiving data from electronic devices according to a number of different wireline and/or wireless networking techniques, including LAN and/or WLAN techniques. In this regard, as shown in FIG. 1 with respect to terminal 10′, the mobile station may include an additional antenna or the like to transmit and/or receive data from such electronic devices (e.g., digital broadcaster).

The mobile station can further include memory, such as a subscriber identity module (SIM) 106, a removable user identity module (R-UIM) or the like, which typically stores information elements related to a mobile subscriber. In addition to the SIM, the mobile station can include other memory. In this regard, like the digital broadcast receiving terminal 36 and the digital broadcaster 32, the mobile station can include volatile memory 108. Also, again like the digital broadcast receiving terminal and the digital broadcaster, the mobile station can include other non-volatile memory 110, which can be embedded and/or may be removable. For example, the other non-volatile memory can comprise embedded or removable multimedia memory cards (MMC”s), Memory Sticks manufactured by Sony Corporation, EEPROM, flash memory, hard disk or the like.

The memories 106, 108, 110 can store any of a number of pieces of information, and data, used by the mobile station to implement the functions of the mobile station. For example, the memories can store an identifier, such as an international mobile equipment identification (IMEI) code, capable of uniquely identifying the mobile station, such as to the MSC 16. The memories can also store pre-broadcast content, such as that received by the mobile station from a digital broadcaster 32, as well as a schedule utilized by a respective content source for broadcasting such content. Also, for example, the memories can store client applications such as a conventional text viewer, audio player, video player, multimedia viewer or the like. In addition, for example, the memories can store a mobile continuity application capable of managing the pre-broadcast content and schedule, and a timing/synchronization application capable of synchronizing presentation of the pre-broadcast content by the mobile station with broadcast of the same content, such as by the digital broadcaster.

As indicated in the background section, if the terminal 10 is downloading large content for online use (e.g., streaming audio and/or video), the time to download the content typically increases, thus increasing the probability that the client will encounter some type of delay, error or interruption in transmission during the download process. Such delays or interruptions in transmission, in turn, can lead to reduced quality of service (QoS) for transmission and reception of such content. As indicated above, the digital broadcaster is capable of broadcasting one or more pieces of content in accordance with a schedule, where one or more pieces of content comprise content stored by the content storage 66A and the schedule comprises a schedule stored by the schedule storage 66B, both maintained by a continuity server 68 of a broadcast facility 62 of a digital broadcaster 32.

To increase the QoS of content otherwise broadcast to the terminal 10, the terminal of embodiments of the present invention is capable of performing the functions of a continuity server 68 of a broadcast facility 62 providing such broadcast content. By performing the functions of a continuity server, the terminal of embodiments of the present invention is capable of storing pre-broadcast content and a schedule 70 for the broadcast of such content by a respective source of the content, before the content source broadcasts the same content as specified by the schedule. Then, the terminal of embodiments of the present invention is capable of providing the pre-broadcast content to a respective client application of the terminal in a manner synchronous with the content source broadcasting the same content. As such, the terminal of embodiments of the present invention is capable of providing the pre-broadcast content in the same manner as if the terminal downloaded the same content as the digital broadcaster broadcasts the content, but without requiring the terminal to download of the broadcast content as the broadcast content is broadcast.

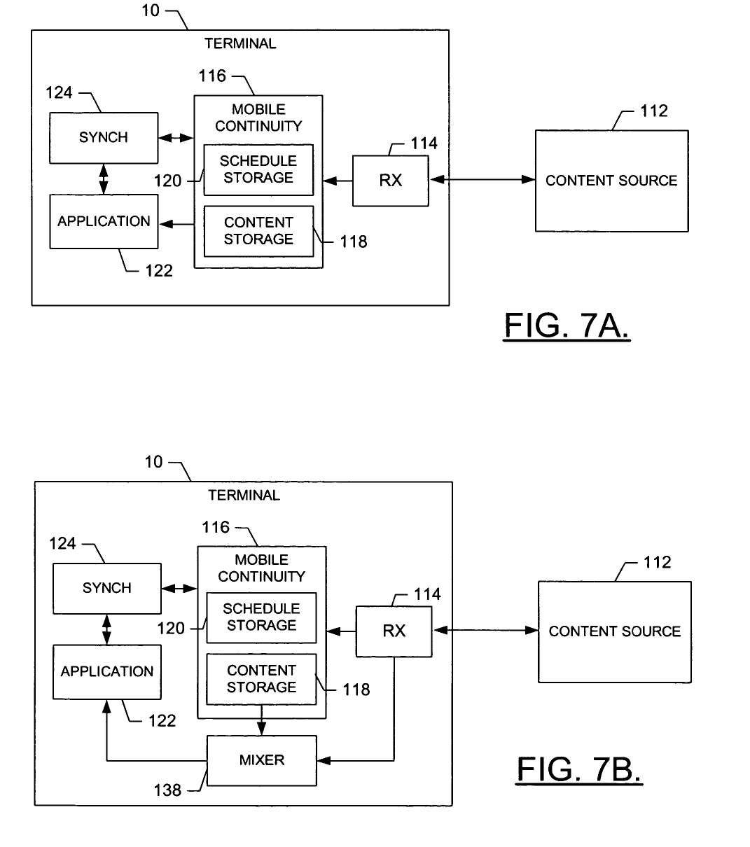

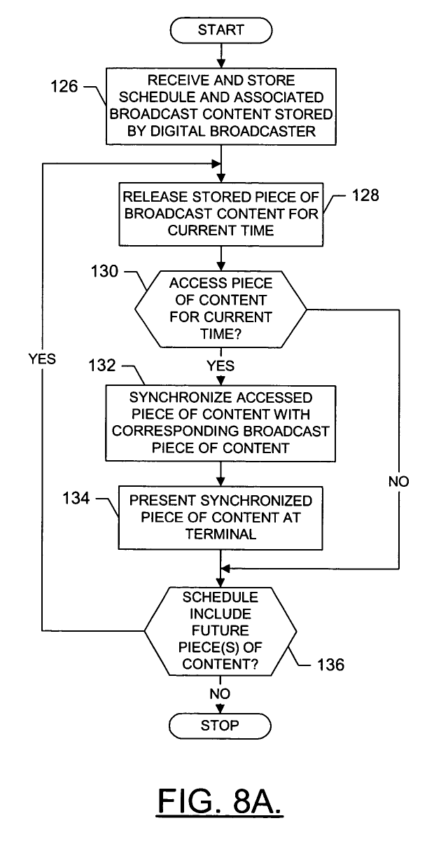

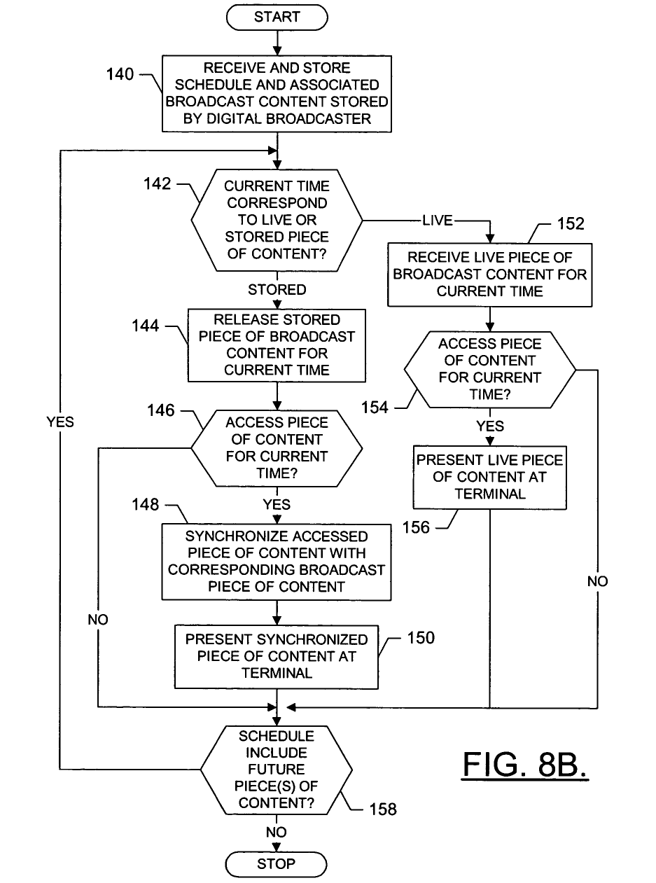

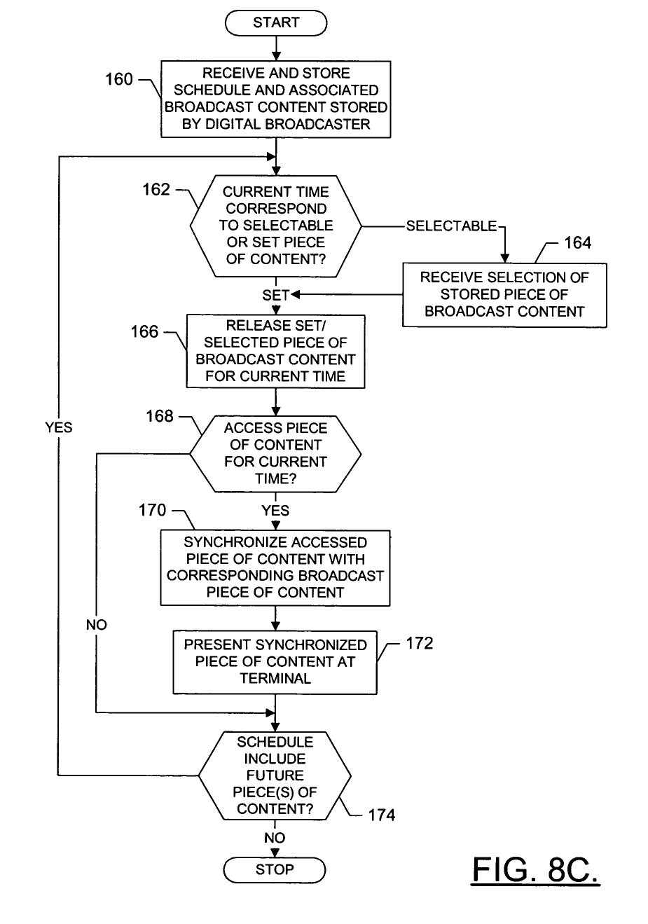

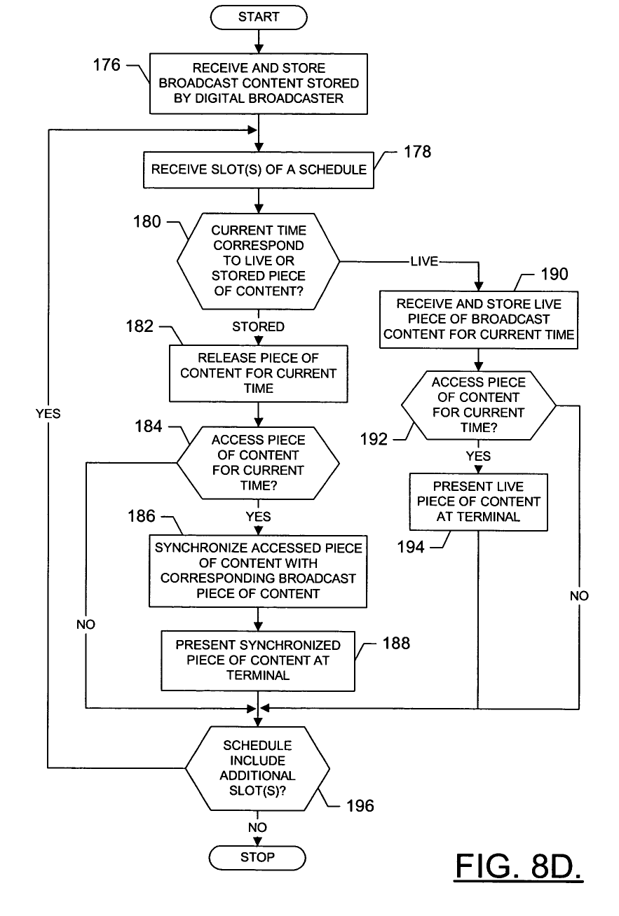

Reference is now drawn to FIGS. 7A and 8A, which illustrate a functional block diagram and flowchart, respectively, of a terminal 10 and method of providing broadcast content to the terminal, in accordance with one embodiment of the present invention. More particularly, FIG. 7A (as well as FIG. 7B—explained below) illustrates a functional block diagram of a terminal downloading one or more pieces of pre-broadcast content from a content source 112. Whereas the content source described below comprises a digital broadcaster 34, it should be understood that the content source can comprise any of a number of different sources (e.g., origin server 22, digital broadcast receiving terminal 36, etc.) capable of providing pre-broadcast content in accordance with embodiments of the present invention. Also, as described below, the terminal described herein with respect to the embodiment of FIGS. 7A, 7B, 8A and 8B, typically comprises terminal 10. It should be understood, however, that the terminal can equally comprise a digital broadcast receiving terminal 36, without departing from the spirit and scope of the present invention.

Further, as described below, the piece(s) of pre-broadcast content comprise content for one or more television and/or radio channels. In this regard, each piece of pre-broadcast content can comprise one or more segments of a television program, a set of one or more television programs, or a set of television programs over a given time period (e.g., a day) for one or more television channels. For example, each piece of pre-broadcast content can comprise pre-broadcast content corresponding to a slot specified in a schedule (e.g., schedule 70—see FIG. 5) or one or more segments of a slot specified in a schedule. Whereas the pre-broadcast content is described herein as comprising content for one or more television and/or radio channels, it should be understood that the pre-broadcast content can comprise any of a number of different types of content, and can be received at the terminal 10 in accordance with any of a number of different wireline and/or wireless transfer techniques.

As shown in FIG. 7A, the terminal 10 can include a receiver (RX) 114 capable of receiving one or more pieces of pre-broadcast content from the content source 112, as shown in block 126 of FIG. 8A. For example, the terminal can download the piece(s) of pre-broadcast content from the content source, and/or the content source can upload the piece(s) of pre-broadcast content to the terminal. The receiver can receive the piece(s) of pre-broadcast content from the content source in accordance with any of a number of different transfer techniques such as, for example, techniques specified by DVB-T, GPRS, EDGE or the like. In addition to the pre-broadcast, the receiver is capable of receiving a schedule specifying a time, including date, the digital broadcaster 34 (i.e., content source 112) is capable of broadcasting the piece(s) of pre-broadcast content to one or more destinations, such as to one or more terminals 10.

The digital broadcaster 34 can send, and the terminal 10 can receive, the piece(s) of pre-broadcast content and schedule at any time prior to the digital broadcaster broadcasting the same piece(s) of content. In one typical embodiment, for example, the terminal receives the piece(s) of pre-broadcast content an amount of time (e.g., twenty-four hours) before broadcast of the same content, where the amount of time equals the amount of time for broadcast of all of the piece(s) of content specified in the schedule.

More particularly, for example, the digital broadcaster can send, and the terminal can receive, the piece(s) of pre-broadcast content nightly or at one or more other times when the delivery network is underutilized. As will be appreciated, sending and receiving the piece(s) of pre-broadcast content at instances when the delivery network is underutilized facilitates agreements between network providers and the content source to lower expenses associated with sending and receiving the piece(s) of pre-broadcast content.

Irrespective of the manner in which the terminal 10 receives the piece(s) of pre-broadcast content and the schedule, before sending the piece(s) of pre-broadcast content and the schedule to the terminal, the digital broadcaster 34 can be capable of processing the piece(s) of pre-broadcast content and the schedule, such as by encrypting and/or transcoding the piece(s) of pre-broadcast content and/or the schedule. Upon receipt of the pre-broadcast content and the schedule, then, the terminal can process the piece(s) of pre-broadcast content and/or schedule for use by the terminal, such as by decrypting the pre-broadcast content and schedule.

The piece(s) of pre-broadcast content and schedule can comprise the content and schedule stored by the content storage 66A and schedule storage 64B maintained by the continuity server 68 of a broadcast facility 62 providing such content to the digital broadcaster. The terminal can operate a mobile continuity application 116. In turn, the mobile continuity application is capable of managing a content storage 118 and a schedule storage 120, which are capable of storing the pre-broadcast content and schedule, respectively, received by the terminal. In one advantageous embodiment, the content storage 118 and schedule storage 120 comprise non-volatile memory (e.g., non-volatile memory 108).

After the terminal 10 stores the piece(s) of pre-broadcast content and the schedule, and as the mobile continuity application 116 maintains the piece(s) of pre-broadcast content in the content storage 118, and the schedule in the schedule storage 120, the terminal, or more particularly the mobile continuity application, can monitor the schedule. More particularly, the mobile continuity application is capable of monitoring the schedule to determine when the current time matches a broadcast time for a piece of pre-broadcast content, where the broadcast time is specified in the schedule stored in the schedule storage. In this regard, the broadcast time typically corresponds to the time the digital broadcaster 32 is capable of broadcasting the same content to one or more destinations, such as one or more terminals, as dictated by the same schedule maintained in schedule storage 66B of the broadcast facility 62 of the respective digital broadcaster.

When the current time matches a broadcast time for a piece of pre-broadcast content, the mobile continuity application 116 can release the respective piece of pre-broadcast content, as shown in block 128. In this regard, the mobile continuity application can release the piece of pre-broadcast content such that the respective piece of pre-broadcast content is capable of being accessed from the content storage 118. Thus, the terminal 10 can also be capable of operating one or more client applications 122, such as a conventional Web browser, text viewer, audio player, video player, multimedia viewer or the like, which are capable of accessing and presenting released piece(s) of pre-broadcast content. After releasing the piece of pre-broadcast content, then, a client application is capable of accessing the released piece of pre-broadcast content, as shown in block 130. As shown, however, the released piece of pre-broadcast content need not be accessed by a client application as will be appreciated by those skilled in the art.

As will also be appreciated by those skilled in the art, the released piece of pre-broadcast content for the current time need not be accessed immediately after being released. The terminal of embodiments of the present invention, however, is capable of synchronizing the accessed pieces of pre-broadcast content with the same content broadcast by the digital broadcaster 32. In this regard, the terminal is also capable of accessing a synchronizing application (SYNCH) 124 capable of synchronizing the accessed piece of pre-broadcast content for the current time with the same content broadcast by the digital broadcaster. More particularly, as shown in block 132, the synchronizing application is capable of synchronizing the accessed piece of pre-broadcast content before the client application 122 presents the piece of pre-broadcast content.

The synchronizing application 124 can synchronize the accessed piece of pre-broadcast content for the current time in any of a number of different manners. In one typical embodiment, the synchronizing application is capable of synchronizing the accessed piece of pre-broadcast content for the current time based upon the broadcast time of the respective piece of pre-broadcast content, as specified by the schedule, and based upon the current time. For example, presume that the accessed piece of pre-broadcast content corresponds to a thirty minute time slot in the schedule beginning at 12:00 PM, and presume that the current time is 12:15 PM. In such an instance, the synchronizing application can identify the second half of the accessed piece of pre-broadcast content as corresponding to the portion of the pre-broadcast content yet to be broadcast by the digital broadcaster 32 to thereby synchronize the accessed piece of pre-broadcast content for the current time with the same content broadcast by the digital broadcaster.

Before, or as, the synchronizing application 124 synchronizes the accessed piece of pre-broadcast content for the current time with the same content broadcast by the digital broadcaster 32, the synchronizing application can, but need not, synchronize the current time maintained by the terminal 10 with the current time maintained by the system. In this regard, the time the digital broadcaster 32 broadcasts the same content as the pre-broadcast content can be based upon the current time maintained by the system. By synchronizing the current times, then, the terminal can further insure that the pre-broadcast content is presented in a synchronous manner with the same content broadcast by the digital broadcaster. Also, by synchronizing the current times, instances of unauthorized or untimely releasing of piece(s) of content by a user of the terminal altering the current time of the terminal, such as by forwarding the current time of the terminal, can be reduced.

The synchronizing application 124 can synchronize the current times in any of a number of different manners. For example, the terminal 10, and thus the synchronizing application, can receive a time broadcast message indicating the current time, where the time broadcast message can be received from the MSC 16, such as in accordance with a cellular (e.g., 1G, 2G, 2.5G, 3G, etc.) communication technique. Upon receipt of the time broadcast message, the synchronizing application can set an internal clock of the terminal to the current time indicated in the time broadcast message. Alternatively, for example, the terminal can send a message to itself or the digital broadcaster, such as a short messaging service (SMS) message sent via the MSC and BS 14. Before the MSC delivers the message to the terminal, or before the MSC delivers a response from the digital broadcaster to the terminal, the MSC can place a time stamp of the current time within the message or response that indicates the current time. Then, upon receipt of the message or response, the synchronizing application can set an internal clock of the terminal to the current time indicated by the time stamp in the message or response.

Irrespective of how the synchronizing application 124 synchronizes the accessed piece of pre-broadcast content or the current time of the terminal 10, after the synchronizing application synchronizes the accessed piece of pre-broadcast content, the synchronizing application can direct the client application 122 at what point to begin presenting the piece of pre-broadcast content, as shown in block 134. Continuing the example from above, the synchronizing application can direct the client application to present the piece of pre-broadcast content beginning midway through the piece of pre-broadcast content. In other terms, the synchronizing application can direct the client application to fast forward the piece of pre-broadcast content to the point of the piece of pre-broadcast content scheduled to be broadcast by the digital broadcaster 32 at 12:15 PM, and thereafter begin presenting the piece of pre-broadcast content at the respective point, such as to a user of the terminal 10.

The terminal can continue to monitor the schedule to determine when the current time matches a broadcast time for a piece of pre-broadcast content, as long as the schedule includes at least one piece of content having a broadcast time after the current time, as shown in block 136. In this regard, the terminal can continue to release piece(s) of pre-broadcast content for the current time (see block 128); and access the released piece(s) of pre-broadcast content (see block 130). Likewise, the terminal can continue to synchronize the released piece(s) of pre-broadcast content with the same content broadcast by the digital broadcaster 32 (see block 132); and present the synchronized piece(s) of pre-broadcast content (see block 134).

As will be appreciated, released piece(s) of pre-broadcast content can expire once the current time is subsequent to the broadcast time specified in the schedule. In such instances, the terminal 10, or more particularly the mobile continuity application 116, can expire such piece(s) of content, and thereafter operate on the expired piece(s) of content in any of a number of different manners. For example, the terminal can delete from the content storage 118 each piece of released pre-broadcast content, as the respective piece of pre-broadcast content expires. Alternatively, for example, the terminal can maintain the piece(s) of expired released pre-broadcast content in the content storage or in another memory location. Further, for example, the terminal can maintain the expired released piece(s) of content, and overwrite the piece(s) of expired released pre-broadcast content as the terminal receives subsequent piece(s) of pre-broadcast content. Thus, as will be appreciated, the terminal can receive subsequent piece(s) of pre-broadcast content for each of one or more subsequent schedules, which are also capable of being received by the terminal. In this manner, the technique of FIG. 8A can continue for each of one or more schedules and corresponding pre-broadcast content received by the terminal.

As indicated above, each schedule stored in schedule storage 66B of a broadcast facility 62 of a digital broadcaster 32 can include, in addition to one or more slots specifying pieces of broadcast content stored in the content storage, one or more pieces of live broadcast content. As also explained above, the digital broadcaster can be capable of transmitting broadcast content, including one or more pieces of broadcast content stored by the content storage 66A of the broadcast facility 64, and/or one or more pieces of live broadcast content, in accordance with the times specified for the respective pieces of content in a schedule 70 stored by the schedule storage 66B. Thus, in accordance with another embodiment of the present invention, a schedule received by the terminal 10 and stored in the schedule storage 120 of the terminal includes one or more slots specifying one or more pieces of live broadcast content not otherwise stored in content storage 118 of the terminal (see block 126 of FIG. 8A).

To allow a client application 122 of the terminal to provide stored pre-broadcast content, as well as live content, in a synchronized and seamless manner, the terminal of one embodiment of the present invention further includes a mixer 138, as shown in FIG. 7B. In this regard, the mixer is capable of combining stored, synchronized piece(s) pre-broadcast content with live piece(s) of pre-broadcast content, and thereafter providing the combined content to the client application. Referring now to FIG. 8B, a method of providing broadcast content according to this embodiment includes, as before, receiving and storing one or more pieces of pre-broadcast content from a digital broadcaster 32 (i.e., content source 112), as well as a schedule including slots specifying times for broadcast of the same content, as shown in block 140. As explained above, the piece(s) of pre-broadcast content and schedule can comprise the content and schedule stored by the content storage 66A and schedule storage 64B maintained by the continuity server 68 of a broadcast facility 62 providing such content to the digital broadcaster. In this embodiment, however, the schedule includes at least one slot specifying broadcast of at least one piece of live broadcast content, where the live broadcast content is not stored in the content storage 66A of the broadcast facility or the content storage 118 of the terminal.

As the mobile continuity application 116 maintains the piece(s) of pre-broadcast content in the content storage 118, and the schedule in the schedule storage 120, the mobile continuity application can monitor the schedule to determine when the current time matches a broadcast time for a piece of stored pre-broadcast content or live broadcast content, as shown in block 142. Then, as shown in block 144, when the current time matches a broadcast time for a piece of stored pre-broadcast content, the mobile continuity application 116 can, as before, release the respective piece of pre-broadcast content. Also as before, after releasing the piece of pre-broadcast content, a client application 122 can access the released piece of pre-broadcast content if so desired, as shown in block 146. After, or as the client application accesses the released piece of pre-broadcast content, the synchronizing application 124 can synchronize the accessed piece of pre-broadcast content for the current time with the same content broadcast by the digital broadcaster, as shown in block 148. Then, the synchronizing application can direct the client application at what point to begin presenting the piece of pre-broadcast content, as shown in block 150.

In contrast to the instances in which the current time matches a broadcast time for a piece of stored pre-broadcast content, when the current time matches a broadcast time for a piece of live broadcast content, the receiver 114 of the terminal 10 can receive the piece of live broadcast content, such as in accordance with DVB-T or GPRS, as the digital broadcaster 32 broadcasts the piece of live broadcast content. As, or after, the terminal receives the piece of live broadcast content, the receiver can process the piece of live broadcast content for use by the terminal, such as by decrypting and/or demodulating the pre-broadcast content, as shown in block 152. Thereafter, a client application can, but need not, access the received piece of live broadcast content, as shown in block 156. After the client application accesses the received piece of live broadcast content, the client application can present the piece of live broadcast content, such as to a user of the terminal 10.

As will be appreciated, even in the instances of presenting live broadcast content, the piece of live broadcast content need not be accessed and presented at the beginning of the slot of the schedule specifying the respective piece of live broadcast content, and thus not at the beginning of the digital broadcaster 32 broadcasting the respective piece of live broadcast content. However, because the terminal receives the piece of live broadcast content as the digital broadcaster broadcasts the same content, irrespective of the point in the broadcast that the terminal 10 begins to access the content, the synchronizing application 124 need not synchronize the accessed piece of live broadcast content with the same content broadcast by the digital broadcaster.

Irrespective of whether a client application 122 accesses and presents a piece of stored pre-broadcast content or live broadcast content, the terminal 10 can continue to monitor the schedule to determine when the current time matches a broadcast time for a piece of stored pre-broadcast content or live broadcast content, as long as the schedule includes at least one piece of content having a broadcast time after the current time, as shown in block 152. Thus, the terminal can continue to release piece(s) of stored pre-broadcast content for the current time (see block 144) or receive piece(s) of live broadcast content (see block 154); and access the released piece(s) of stored pre-broadcast content and live broadcast content (see blocks 146, 156). Likewise, the terminal can continue to synchronize the released piece(s) of stored pre-broadcast content with the same content broadcast by the digital broadcaster 32 (see block 148); and present the piece(s) of stored pre-broadcast content and live broadcast content (see blocks 150, 158).

As will be appreciated, in one or more instances, it may be desirable for the schedule to include one or more slots that each specify broadcast of a selectable piece of content. In such instances, the terminal 10 can store one or more pieces of content capable of being selected for the respective slot(s) of the schedule. Then, before the broadcast time of each slot, the digital broadcaster 34 (i.e., content source 112) or other network entity can select a piece of pre-broadcast content to broadcast to one or more destinations, such as to one or more terminals, at the broadcast time. The terminal can receive the selection and thereafter operate as if the schedule included the selected piece of pre-broadcast in the respective slot.

Referring to FIG. 8C, a method of providing broadcast content according to this embodiment includes, as before, receiving and storing one or more pieces of pre-broadcast content from a digital broadcaster 32 (i.e., content source 112), as well as a schedule including slots specifying times for broadcast of the same content, as shown in block 160. As explained above, the schedule can include one or more slots specifying pieces of broadcast content stored in the content storage 66A maintained by the continuity server 68 of a broadcast facility 62, and thus the content storage 118 of the terminal. In contrast to the embodiments described above, however, the schedule also includes one or more slots that each specify broadcast of a selectable piece of content. In this regard, in addition to receiving and storing the piece(s) of pre-broadcast content specified in the schedule, the terminal is also capable of receiving and storing the selectable piece(s) of content for the slot(s) specifying broadcast of such pre-broadcast content.

As the mobile continuity application 116 maintains the piece(s) of pre-broadcast content in the content storage 118, and the schedule in the schedule storage 120, the mobile continuity application can monitor the schedule. In this regard, the mobile continuity application can monitor the schedule to determine when the current time matches a broadcast time for a piece of stored pre-broadcast content set or specified for the respective slot of the schedule, or specifies selectable pre-broadcast content, as shown in block 162. Then, as shown in block 164, when the current time matches a broadcast time for a selectable piece of pre-broadcast content, the terminal 10 can receive a selection of the piece of pre-broadcast content for the current time, such as in accordance with DVB-T, DVB-H, GPRS or EDGE, as the digital broadcaster 32 broadcasts the same piece of content, as shown in block 164. Alternatively, the terminal can receive the selection before the digital broadcaster broadcasts the same piece of content, but after the digital broadcaster or other network entity selects the respective piece of content. Irrespective of when the terminal receives the selection for the piece of pre-broadcast content, the terminal can thereafter modify the schedule to specify the selected piece of pre-broadcast content in the respective slot of the schedule.

As shown in block 166, after receiving the selection of a piece of content for the current time, or when the current time matches a broadcast time for a piece of stored pre-broadcast content set for the respective slot of the schedule, the mobile continuity application 116 can, as before, release the respective piece of pre-broadcast content. Also as before, after releasing the piece of pre-broadcast content, a client application 122 can access the released piece of pre-broadcast content if so desired, as shown in block 168. After, or as the client application accesses the released piece of pre-broadcast content, the synchronizing application 124 can synchronize the accessed piece of pre-broadcast content for the current time with the same content broadcast by the digital broadcaster, as shown in block 170. Then, the synchronizing application can direct the client application at what point to begin presenting the piece of pre-broadcast content, as shown in block 172. The terminal 10 can continue to monitor the schedule as long as the schedule includes at least one piece of content having a broadcast time after the current time, as shown in block 174.

As will also be appreciated, in one or more instances, it may be desirable for the terminal 10 to receive and store one or more pieces of pre-broadcast content without a schedule. Then, at one or more points before or as the digital broadcaster 32 (i.e., content source 112) broadcasts the same piece(s) of content, the terminal can receive portions of the schedule including the slot(s) of the broadcast content. By storing the piece(s) of content without the schedule, the schedule can be generated, or broadcast time(s) of the piece(s) of pre-broadcast content can be determined, subsequent to determining the piece(s) of content to broadcast. This may be beneficial in instances such as those involving the repeated broadcast of the same content (e.g., musical videos), where the broadcast time(s) of the content may frequently change between the period of time of one schedule to the next schedule.

Referring to FIG. 8D, a method of providing broadcast content according to this embodiment includes, as before, receiving and storing one or more pieces of pre-broadcast content from a digital broadcaster 32 (i.e., content source 112), as shown in block 176. In contrast to the previous embodiments, however, the terminal does not receive a schedule from the digital broadcaster. Then, as the mobile continuity application 116 maintains the piece(s) of pre-broadcast content in the content storage 118, the terminal 10, and thus the mobile continuity application, can receive one or more slots of a schedule, where each slot specifies, as before, a broadcast time of a piece of pre-broadcast content, as shown in block 178. The terminal can receive the slot(s) of the schedule in any of a number of different manners, such as from the digital broadcaster in accordance with DVB-T, DVB-H, GPRS or EDGE. Also, the terminal can receive the slot(s) at any point before the digital broadcaster broadcasts the piece(s) of pre-broadcast content specified by the slot(s), or alternatively, as the digital broadcaster broadcasts the piece(s) of pre-broadcast content.

After receiving the slot(s), the mobile continuity application 116 can monitor the slot(s) to determine when the current time matches a broadcast time specified in one of the slot(s) for a piece of content, as shown in block 180. In this regard, the respective slot may specify a piece of pre-broadcast content stored in the content storage 118 or a piece of live broadcast content not stored in the content storage. Then, when the current time matches a broadcast time for a piece of stored pre-broadcast content, as specified in one of the slot(s), the respective piece of pre-broadcast content can be released, accessed, synchronized and presented, as shown in blocks 182-188.

Similar to the embodiment of FIG. 8B, when the current time matches a broadcast time for a piece of live broadcast content, as specified in one of the slot(s), the receiver 114 of the terminal 10 can receive and process the piece of live broadcast content as the digital broadcaster 32 broadcasts the piece of live broadcast content, as shown in block 190. In addition, the mobile continuity application 116 can store the received piece of live broadcast content in the content storage 118, such as for subsequent release should a future schedule slot again specify the respective piece of content. Thereafter, as in the embodiment of FIG. 8B, a client application can, but need not, access and present the received piece of live broadcast content, as shown in blocks 192 and 194. Irrespective of whether a client application 122 accesses and presents a piece of stored pre-broadcast content or live broadcast content, the terminal 10 can continue to receive slot(s) of the schedule as long as the schedule includes additional slots, as shown in block 196. For each of the received slot(s), the terminal can then operate as described above with respect to blocks 180-194.

Embodiments of the present invention are therefore capable of increasing the QoS of broadcast content presented by the terminal 10. In this regard, the terminal of embodiments of the present invention is capable of performing the functions of a continuity server 68 of a broadcast facility 62 providing such broadcast content. By performing the functions of a continuity server, the terminal of embodiments of the present invention is capable of storing broadcast content, otherwise stored by the broadcast facility, before a content source broadcasts the same content as specified by a schedule. Then, as the content source broadcasts the content specified by the schedule, whether stored or live broadcast content, the terminal can retrieve the same stored content from local memory and present the content in a manner synchronous with the broadcast. As such, the terminal is capable of presenting broadcast content as the content is broadcast without downloading the otherwise stored portions of the content at the time of broadcast. The terminal can therefore be capable of presenting the broadcast content irrespective of errors, interruptions or delays that may occur in the download of such content as the content is broadcast.

According to one aspect of the present invention, all or a portion of the system of the present invention, such all or portions of the terminal 10, digital broadcast receiving terminal 36, and/or a digital broadcaster 32, generally operates under control of a computer program product (e.g., mobile continuity application 116, client application 122, synchronization application 124, etc.). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 7A and 7B, and 8A, 8B, 8C and 8D, are functional block diagrams and flowcharts, respectively, of methods, systems and program products according to the invention. It will be understood that each block or step of the functional block diagrams and flowcharts, and combinations of blocks in the functional block diagrams and flowcharts, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the functional block diagrams and flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the functional block diagrams and flowcharts. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the functional block diagrams and flowcharts.

Accordingly, blocks or steps of the flowcharts support combinations of means for performing the specified functions, combinations of steps for performing the specified functions and program instruction means for performing the specified functions. It will also be understood that each block or step of the functional block diagrams and flowcharts, and combinations of blocks or steps in the functional block diagrams and flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for providing broadcast content, the system comprising:
a content source comprising a continuity server capable of maintaining at least one piece of content and a schedule, wherein the schedule specifies at least one broadcast time the content source broadcasts the at least one piece of content, and wherein the content source is capable of broadcasting the at least one piece of content in accordance with the schedule; and
a terminal capable of storing, in a memory, at least one piece of pre-broadcast content comprising the same at least one piece of content maintained by the continuity server, wherein the terminal is capable of accessing at least one piece of pre-broadcast content from the memory in accordance with the schedule, and thereafter presenting the accessed at least one piece of pre-broadcast content as the content source broadcasts the same at least one piece of content.

2. A system according to claim 1, wherein the terminal is capable of synchronizing the accessed at least one piece of pre-broadcast content with the same at least one piece of content broadcast by the content source before presenting the accessed at least one piece of pre-broadcast content, and wherein the terminal is capable of presenting the synchronized at least one piece of pre-broadcast content.

3. A system according to claim 1, wherein the terminal is capable of storing the at least one piece of pre-broadcast content before the content source broadcasts the same at least one piece of content.

4. A system according to claim 1, wherein the content source is capable of sending, to the terminal, the at least one piece of content maintained by the continuity server, and wherein the terminal is capable of receiving and storing the received at least one piece of content as the at least one piece of pre-broadcast content.

5. A system according to claim 4, wherein the content source is capable of at least one of encoding and transcoding the at least one piece of content and the schedule before sending the at least one piece of content and the schedule to the terminal, and wherein when the content source encodes the at least one piece of content, the terminal is capable of receiving the encoded at least one piece of content, and thereafter decoding the encoded at least one piece of content.

6. A system according to claim 1, wherein the schedule maintained by the continuity server also specifies at least one broadcast time the content source broadcasts at least one piece of live broadcast content, wherein the terminal is capable of receiving at least one piece of live broadcast content when a current time matches the broadcast time of the respective at least one piece of live broadcast content, wherein the terminal is capable of accessing at least one of at least one piece of pre-broadcast content stored in by the terminal and at least one piece of live broadcast content received by terminal, and wherein the terminal is capable of presenting at least one of the accessed at least one piece of pre-broadcast content and the accessed at least one piece of live broadcast content.

7. A system according to claim 1, wherein the terminal is capable of releasing each piece of pre-broadcast content when a current time of the terminal matches the broadcast time the content source broadcasts the same piece of content, and wherein the terminal is capable of accessing at least one released piece of pre-broadcast content.

8. A system according to claim 7, wherein the content source is capable of broadcasting the at least one piece of content when a current time of the content source matches the at least one broadcast time of the schedule, and wherein the terminal is also capable of synchronizing the current time of the terminal with the current time of the content source.

9. A system according to claim 7, wherein the terminal is also capable of expiring each released piece of pre-broadcast content when the current time is subsequent to the broadcast time, and wherein the terminal is capable of maintaining, in the memory, at least one expired piece of pre-broadcast content.

10. A system according to claim 7, wherein the terminal is also capable of expiring each released piece of pre-broadcast content when the current time is subsequent to the broadcast time, and wherein the terminal is capable of deleting, from the memory, at least one expired piece of pre-broadcast content.

11. A system according to claim 10, wherein the terminal is capable of maintaining at least one expired piece of pre-broadcast content in the memory of the terminal, and wherein the terminal is capable of overwriting at least one expired piece of pre-broadcast content with at least one subsequent piece of pre-broadcast content.

12. A system according to claim 1, wherein the terminal is also capable of storing a schedule comprising the same schedule maintained by the continuity server.

13. A system according to claim 12, wherein the schedule includes at least one slot specifying broadcast of a selectable piece of pre-broadcast content at a respective broadcast time, wherein the terminal is capable of receiving a selection of at least one piece of pre-broadcast content for the at least one slot, and thereafter modifying the schedule to specify the selected at least one piece of pre-broadcast content in the at least one slot.

14. A system according to claim 1, wherein the schedule includes at least one slot specifying a broadcast time and a piece of pre-broadcast content, wherein the terminal is capable of receiving at least one slot of the schedule, and wherein the terminal is capable of accessing at least one piece of pre-broadcast content in accordance with the at least one slot received by the terminal.

15. A terminal for receiving broadcast content, the terminal comprising:
a memory comprising a content storage capable of storing at least one piece of pre-broadcast content; and
a controller capable of operating a client application capable of accessing at least one piece of pre-broadcast content from the content storage in accordance with a schedule specifying at least one broadcast time a content source broadcasts the same at least one piece of content, and thereafter presenting the accessed at least one piece of pre-broadcast content as the content source broadcasts the same at least one piece of content.

16. A terminal according to claim 15, wherein the controller is also capable of operating a synchronizing application capable of synchronizing the accessed at least one piece of pre-broadcast content with the same at least one piece of content broadcast by the content source, and wherein the client application is capable of presenting the synchronized at least one piece of pre-broadcast content.

17. A terminal according to claim 15, wherein the content storage of the memory is capable of storing the at least one piece of pre-broadcast content before the content source broadcasts the same at least one piece of content.

18. A terminal according to claim 15 further comprising:
a receiver capable of receiving at least one piece of content maintained by a continuity server of a content source, and wherein the content storage is capable of storing the received at least one piece of content as the at least one piece of pre-broadcast content.

19. A terminal according to claim 18, wherein the client application is capable of accessing at least one piece of pre-broadcast content as the content source broadcasts the same at least one piece of content maintained by the continuity server and broadcast in accordance with a schedule maintained by the continuity server, wherein the schedule specifying at least one broadcast time comprises the schedule maintained by the continuity server.

20. A terminal according to claim 19, wherein the receiver is capable of receiving at least one piece of content at least one of encoded and transcoded at the content source, and wherein when the content source encodes the at least one piece of content, the receiver is capable of receiving the encoded at least one piece of content, and thereafter decoding the encoded at least one piece of content.

21. A terminal according to claim 15, wherein the schedule also specifies at least one broadcast time a content source broadcasts at least one piece of live broadcast content, and wherein the terminal further comprises:
a receiver capable of receiving at least one piece of live broadcast content when a current time matches the broadcast time of the respective at least one piece of live broadcast content,
wherein the client application is capable of accessing at least one of at least one piece of pre-broadcast content stored in the memory of the terminal and at least one piece of live broadcast content received by the receiver, and wherein the client application is capable of presenting at least one of the accessed at least one piece of pre-broadcast content and the accessed at least one piece of live broadcast content.

22. A terminal according to claim 15, wherein the controller is also capable of operating a mobile continuity application capable of releasing each piece of pre-broadcast content when a current time of the terminal matches the broadcast time the content source broadcasts the same piece of content,
and wherein the client application is capable of accessing at least one released piece of pre-broadcast content.

23. A terminal according to claim 22, wherein the content source broadcasts the same at least one piece of content when a current time of the content source matches the at least one broadcast time, and wherein the controller is further capable of operating a synchronizing application capable of synchronizing the current time of the terminal with the current time of the content source.

24. A terminal according to claim 22, wherein the mobile continuity application is also capable of expiring each released piece of pre-broadcast content when the current time is subsequent to the broadcast time, and wherein the controller is capable of maintaining at least one expired piece of pre-broadcast content in the content storage.

25. A terminal according to claim 22, wherein the mobile continuity application is also capable of expiring each released piece of pre-broadcast content when the current time is subsequent to the broadcast time, and wherein the controller is capable of deleting at least one expired piece of pre-broadcast content from the content storage.

26. A terminal according to claim 25, wherein the controller is capable of maintaining each expired piece of pre-broadcast content in the content storage, and wherein the controller is capable of overwriting at least one expired piece of pre-broadcast content with at least one subsequent piece of pre-broadcast content.

27. A terminal according to claim 15, wherein the memory further comprises a schedule storage capable of storing the schedule.

28. A terminal according to claim 27, wherein the schedule includes at least one slot specifying broadcast of a selectable piece of pre-broadcast content at a respective broadcast time, wherein the controller is further capable of operating a mobile continuity application capable of receiving a selection of at least one piece of pre-broadcast content for the at least one slot, and thereafter modifying the schedule to specify the selected at least one piece of pre-broadcast content in the at least one slot.

29. A terminal according to claim 15, wherein the schedule includes at least one slot specifying a broadcast time and a piece of pre-broadcast content, wherein the controller is further capable of operating a mobile continuity application capable of receiving at least one slot of the schedule, and wherein the client application is capable of accessing at least one piece of pre-broadcast content in accordance with the at least one slot received by the mobile continuity application.

30. A method of providing broadcast content, the method comprising:
storing, in a memory of a terminal, at least one piece of pre-broadcast content;
accessing at least one piece of pre-broadcast content from the memory of the terminal in accordance with a schedule specifying at least one broadcast time a content source broadcasts the same at least one piece of content; and
presenting the accessed at least one piece of pre-broadcast content as the content source broadcasts the same at least one piece of content.

31. A method according to claim 30 further comprising:
synchronizing the accessed at least one piece of pre-broadcast content with the same at least one piece of content broadcast by the content source,
wherein presenting at least one piece of pre-broadcast content comprises presenting the synchronized at least one piece of pre-broadcast content.

32. A method according to claim 30, wherein storing at least one piece of pre-broadcast content comprises storing at least one piece of pre-broadcast content before the content source broadcasts the same at least one piece of content.

33. A method according to claim 30 further comprising:
receiving, at the terminal, at least one piece of content maintained by a continuity server of a content source,
wherein storing at least one piece of pre-broadcast content comprises storing the received at least one piece of content as at least one piece of pre-broadcast content.

34. A method according to claim 33 further comprising:
broadcasting, from the content source, at least one piece of content maintained by the continuity server in accordance with a schedule maintained by the continuity server wherein the schedule specifying at least one broadcast time comprises the schedule maintained by the continuity server,
wherein accessing at least one piece of pre-broadcast content comprises accessing at least one piece of pre-broadcast content as the content source broadcasts the same at least one piece of content maintained by the continuity server.

35. A method according to claim 34 further comprising:
processing at least one piece of content at the content source, and thereafter sending the processed at least one piece of content to the terminal, wherein processing at least one piece of content comprises at least one of encoding and transcoding at least one piece of content,
wherein receiving at least one piece of content comprises receiving the processed at least one piece of content, and when the content source encodes the at least one piece of content, decoding the encoded at least one piece of content.

36. A method according to claim 30, wherein the schedule also specifies at least one broadcast time a content source broadcasts at least one piece of live broadcast content, and wherein the method further comprises:
receiving, at the terminal, at least one piece of live broadcast content when a current time matches the broadcast time of the respective at least one piece of live broadcast content,
wherein accessing at least one piece of pre-broadcast content comprises accessing at least one of at least one piece of pre-broadcast content stored in the memory of the terminal and at least one piece of live broadcast content received at the terminal, and wherein presenting the accessed at least one piece of pre-broadcast content comprises presenting at least one of the accessed at least one piece of pre-broadcast content and the accessed at least one piece of live broadcast content.

37. A method according to claim 30 further comprising:
releasing each piece of pre-broadcast content when a current time of the terminal matches the broadcast time the content source broadcasts the same piece of content,
wherein accessing at least one piece of pre-broadcast content comprises accessing at least one released piece of pre-broadcast content.

38. A method according to claim 37, wherein the content source broadcasts the same at least one piece of content when a current time of the content source matches the at least one broadcast time, and wherein the method further comprises:
synchronizing the current time of the terminal with the current time of the content source.

39. A method according to claim 37 further comprising:
expiring each released piece of pre-broadcast content when the current time is subsequent to the broadcast time; and
maintaining, in the memory of the terminal, at least one expired piece of pre-broadcast content.

40. A method according to claim 37 further comprising:
expiring each released piece of pre-broadcast content when the current time is subsequent to the broadcast time; and
deleting, from the memory of the terminal, at least one expired piece of pre-broadcast content.

41. A method according to claim 40 further comprising:
maintaining at least one expired piece of pre-broadcast content in the memory of the terminal,
wherein deleting at least one expired piece of pre-broadcast content comprises overwriting at least one expired piece of pre-broadcast content maintained in memory with at least one subsequent piece of pre-broadcast content.

42. A method according to claim 30, wherein storing at least one piece of pre-broadcast content further comprises storing the schedule.

43. A method according to claim 42, wherein the schedule includes at least one slot specifying broadcast of a selectable piece of pre-broadcast content at a respective broadcast time, and wherein the method further comprises:
receiving a selection of at least one piece of pre-broadcast content for the at least one slot; and
modifying the schedule to specify the selected at least one piece of pre-broadcast content in the at least one slot.

44. A method according to claim 30, wherein the schedule includes at least one slot specifying a broadcast time and a piece of pre-broadcast content, and wherein the method further comprises:
receiving at least one slot of the schedule at the terminal,
wherein accessing at least one piece of pre-broadcast content comprises accessing at least one piece of pre-broadcast content in accordance with the at least one slot received at the terminal.

45. A computer program product for providing broadcast content, the computer program product comprising a computer-readable storage medium having computer-readable program code portions stored therein, the computer-readable program code portions comprising:
a first executable portion for storing, in a memory of a terminal, at least one piece of pre-broadcast content;
a second executable portion for accessing at least one piece of pre-broadcast content from the memory of the terminal in accordance with a schedule specifying at least one broadcast time a content source broadcasts the same at least one piece of content; and
a third executable portion for presenting the accessed at least one piece of pre-broadcast content as the content source broadcasts the same at least one piece of content.

46. A computer program product according to claim 45 further comprising:
a fourth executable portion for synchronizing the accessed at least one piece of pre-broadcast content with the same at least one piece of content broadcast by the content source,
wherein the third executable portion is adapted to present the synchronized at least one piece of pre-broadcast content.

47. A computer program product according to claim 45, wherein the first executable portion is adapted to store at least one piece of pre-broadcast content before the content source broadcasts the same at least one piece of content.

48. A computer program product according to claim 45 further comprising:
a fourth executable portion for receiving, at the terminal, at least one piece of content maintained by a continuity server of a content source, wherein the first executable portion is adapted to store the received at least one piece of content as at least one piece of pre-broadcast content.

49. A computer program product according to claim 48, wherein the second executable portion is adapted to access at least one piece of pre-broadcast content as the content source broadcasts the same at least one piece of content maintained by the continuity server and broadcast in accordance with a schedule maintained by the continuity server, wherein the schedule specifying at least one broadcast time comprises the schedule maintained by the continuity server.

50. A computer program product according to claim 49, wherein the fourth executable portion is adapted to receive at least one piece of content at least one of encoded and transcoded at the content source, and wherein when the content source encodes the at least one piece of content, the fourth executable portion is adapted to decode the encoded at least one piece of content

51. A computer program product according to claim 45, wherein the schedule also specifies at least one broadcast time a content source broadcasts at least one piece of live broadcast content, and wherein the computer program product further comprises:
a fourth executable portion for receiving, at the terminal, at least one piece of live broadcast content when a current time matches the broadcast time of the respective at least one piece of live broadcast content,
wherein the second executable portion is adapted to access at least one of at least one piece of pre-broadcast content stored in the memory of the terminal and at least one piece of live broadcast content received at the terminal, and wherein the third executable portion is adapted to present at least one of the accessed at least one piece of pre-broadcast content and the accessed at least one piece of live broadcast content.

52. A computer program product according to claim 45 further comprising:
a fourth executable portion for releasing each piece of pre-broadcast content when a current time of the terminal matches the broadcast time the content source broadcasts the same piece of content,
wherein the second executable portion is adapted to access at least one released piece of pre-broadcast content.

53. A computer program product according to claim 52, wherein the content source broadcasts the same at least one piece of content when a current time of the content source matches the at least one broadcast time, and wherein the computer program product further comprises:
a fifth executable portion for synchronizing the current time of the terminal with the current time of the content source.

54. A computer program product according to claim 52 further comprising:
a fifth executable portion for expiring each released piece of pre-broadcast content when the current time is subsequent to the broadcast time; and
a sixth executable portion for maintaining, in the memory of the terminal, at least one expired piece of pre-broadcast content.

55. A computer program product according to claim 52 further comprising:
a fifth executable portion for expiring each released piece of pre-broadcast content when the current time is subsequent to the broadcast time; and
a sixth executable portion for deleting, from the memory of the terminal, at least one expired piece of pre-broadcast content.

56. A computer program product according to claim 55 further comprising:
a seventh executable portion for maintaining at least one expired piece of pre-broadcast content in the memory of the terminal,
wherein the sixth executable portion is adapted to overwrite at least one expired piece of pre-broadcast content maintained in memory with at least one subsequent piece of pre-broadcast content.

57. A computer program product according to claim 45, wherein the first executable portion is further adapted to store the schedule.

58. A computer program product according to claim 57, wherein the schedule includes at least one slot specifying broadcast of a selectable piece of pre-broadcast content at a respective broadcast time, and wherein the computer program product further comprises:
a fourth executable portion for receiving a selection of at least one piece of pre-broadcast content for the at least one slot; and
a fifth executable portion for modifying the schedule to specify the selected at least one piece of pre-broadcast content in the at least one slot.

59. A computer program product according to claim 45, wherein the schedule includes at least one slot specifying a broadcast time and a piece of pre-broadcast content, and wherein the computer program product further comprises:
a fourth executable portion for receiving at least one slot of the schedule at the terminal,
wherein the second executable portion is adapted to access at least one piece of pre-broadcast content in accordance with the at least one slot received at the terminal.
